(19) United States
(12) Patent Application Publication
(10) Pub. No.: US 2021/0395900 A1
(43) Pub. Date: Dec. 23, 2021

(54) PROCESS FOR BIOFOULING COHIBITION IN MARINE ENVIRONMENTS

(71) Applicants: Roberto KESSEL, Rio De Janeiro (BR); Carlos CARLONI, Rio De Janeiro (BR)

(72) Inventors: Roberto KESSEL, Rio De Janeiro (BR); Carlos CARLONI, Rio De Janeiro (BR); Ricardo COUTINHO, Arraial Do Cabo (BR); Luciana MESSANO, Arraial Do Cabo (BR)

(21) Appl. No.: 17/296,474

(22) PCT Filed: Nov. 22, 2018
(86) PCT No.: PCT/BR2018/050431

§ 371 Date: May 24, 2021

(51) Int. Cl. C23F 13/08; B63B 59/04

(52) U.S. Cl. CPC C23F 13/08; B63B 59/04

(57) ABSTRACT

The present invention relates to the field of technology for preventing the bio-fouling of floating equipment in marine environments and other structures, and particularly the use of electronic devices that assist in the cleaning process. It comprises the steps of: Step 1) Identification; Sub-step 1a) Location; Sub-step 1b) Sizing; Step 2) Cleaning; Step 3) Measuring; Step 4) Partitioning; Step 5) Coupling; Step 6) Inspection; and Step 7) Resizing. By means of the aforementioned steps, the method disclosed in the present invention makes it possible to create electric fields that create environmental disturbances capable of inhibiting fouling by sessile organisms within parcels of sea water in dynamic and/or static conditions, on vessels, oil exploration platforms, jetties, etc.

### FIELD OF INVENTION

The present invention is comprised in the field of technologies to prevent the biofouling of floating equipment in maritime, river or lake environments and other structures, especially considering the use of electronic devices that assist in the cleaning process.

### BACKGROUND OF THE INVENTION

Biological incrustation performed by sessile organisms (Biofouling)—such as barnacles, bryozoans, bivalves and sun coral, a problematic invasive species for the off-shore industry—demand frequent activity in the naval sector, which is cleaning ship hulls and vessel hulls in general, as well as other structures submitted to traffic or anchoring in coastal, fluvial or lake waters. In addition to vessels, circulation pipes in maritime, fluvial or lake environments are also submitted to similar biological incrustation.

The cleaning required for the hulls of vessels and other structures is usually done by drivers or on barrages, proving to be very expensive and submitted to strong environmental control.

The state of art presents means to control or mitigate biofouling, which involve the use of toxic paints, which in addition to questionable efficiency, they can also contribute to the environmental degradation.

The importance of carrying out the correct cleaning procedures can be underscored by observing the fact that, once the biofouling process has started, organisms tend to multiply and even deform the hydrodynamic profile of vessels and structures and even impact their weight. In view of this observation, it is clear that biological incrustation of the surface in contact with the marine environment reduce the performance of the equipment, implying an increase in fuel consumption and consequent aggression to the environment and loss of industrial productivity, in addition to forced stops for scraping foul organisms.

Technologies for the generation of continuous electric field technologies are available in the state of the art, and technologies for the generation of variable random electric field have not been observed, as proposed by the present invention. Publications that best represent the field of the present invention will be detailed below.

Document US20110100804, “ELECTROCHEMICAL ANTIFOULING SYSTEM FOR SEAWATER-WETTED STRUCTURES”, describes an electrochemical antifouling system to prevent fouling organisms from attaching to structures submerged in seawater. The system includes a direct current circuit to create an electrolytic environment in seawater; said circuit including an adjustable current source, a network electrode having a unique metallic component in order to provide a dimensionally stable network structure—the network electrode being electrically isolated from a surface of a structure submerged in sea water, at least one corrosion resistant counter electrode—having polarity opposite to the mains electrode and disposed away from it, and a switching device configured to switch the mains electrode to (a) continuous operation mode, and (b) temporary depletion mode, in which the mains electrode is disposed at a distance from the surface of the structure immersed in seawater so that the surface is within an area of influence to increase the pH value of seawater as a result of electrolysis. However, in a differential way, the present invention does not depict an electrochemist.

Document JP2007055568, “LOW-FREQUENCY CURRENT TYPE SHIP BOTTOM ANTI-FOULING SYSTEM”, provides a low-frequency current antifouling system capable of effectively preventing the adherence of organisms such as crustaceans, barnacles, shellfish, and algae on the bottom of ships. Electrodes arranged on underwater outer edges are described and the current supplied is converted into low frequency current. The low frequency current is conducted between the electrodes with the water around the ship acting as a conductor to prevent the fixation of organisms in the hull. In particular, the current is conducted simultaneously, cyclically or randomly, from a selected anode electrode, from a selected anodic electrode to a variety of cathode electrodes and the direction and intensity of the low-frequency current underwater are controlled to achieve the antifouling effect. However, in a differential and advantageous way, the present invention uses both the immersed structure, when conductive, and the water line adjacent to it in order to randomly contain variable electric fields, introducing unfavorable disturbances, as such, to the development of fouling organisms.

Document JP2021888, “ANTIFOULING METHOD”, describes an invention that aims to maintain the antifouling effect by applying a small current between a conductive coating layer, applied to a body in contact with seawater and an electrode, placed close to the coating layer, so that the potential of the coating layer shifts over a specified period A conductive coating layer is given, provided on the inner surface of a steel tube, and a reference electrode is inserted and fixed in a hole made in the steel tube, so that the tip of the electrode slightly advances in the steel tube. The adjacent steel tubes are joined with a flange with an electrode placed between them. The electrode and the reference electrode are connected to a function generator through a potentiostat. Seawater is flowed at a flow rate of 0.5 m/s through the tube and a direct current of 40-100 mA is applied, with the potential difference between the coating layer and the reference electrode controlled in order to periodically vary in a range of 1.2 to 0.6 V. However, in a different way, there is no need for a reference electrode in the present invention for field application. Its efficiency results from the fields being random in both amplitude and frequency.

In document U.S. Pat. No. 5,143,011, “METHOD AND APPARATUS FOR INHIBITING BARNACLE GROWTH ON BOATS”, a system for inhibiting the growth of barnacles and other marine organisms in ship hulls is revealed. The system includes a plurality of transducers or vibrators coupled to the hull and alternately energized at a frequency of 25Hz through a power source, preferably the ship battery, and a control system. The system has two operating modes, one continuous and one periodic. Even when the battery voltage falls below the predetermined level, the transducers are automatically de-energized to allow the battery to be recharged and the transducers to be subsequently energized. However, in a different way, the present invention reaffirms itself, working with electric and non-mechanical fields that, even at low frequencies, may contribute to the propagation of micro cracks in the structure subjected to such vibrations.

In order to solve the deficiencies of the state of art, the present invention reveals a process with the purpose of inhibiting the beginning of the biological activity that results in the unwanted adhesion of organisms. The process revealed here is able of creating environmental disturbances, resulting from electric fields of varying values generated by electronic equipment, and which are proven to be unfavorable to the development of living beings, including microorganisms.

### BRIEF DESCRIPTION OF THE INVENTION

The present invention relates to a process for preventing biofouling in marine environments, comprising the steps of:

Step 1) Identification;

Substep 1a) Localization;

Substep 1b) Dimensioning;

Step 2) Cleaning;

Step 3) Measurement;

Step 4) Compartmentation;

Step 5) Coupling;

Step 6) Inspection, and

Step 7) Resizing

Through these steps, the process revealed in the present invention allows the implementation of electric fields that create environmental disturbances capable of inhibiting incrustation of sessile organisms inside portions of sea, river and lake waters under dynamic and/or static conditions, ships, oil exploration platforms, jetties etc.

### BRIEF DESCRIPTION OF THE FIGURES

FIG. 1 is a schematic representation of the present invention, in which a flowchart illustrating the steps followed in the process disclosed here is presented.

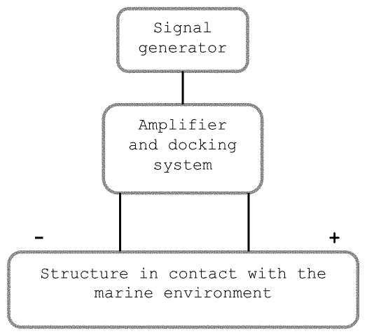

### DETAILED DESCRIPTION OF THE INVENTION

The present invention relates to a process for inhibiting biofouling by sessile organisms in marine environments, comprising the steps of:

Step 1) Identification;

Substep 1a) Localization;

Substep 1b) Dimensioning;

Step 2) Cleaning;

Step 3) Measurement;

Step 4) Compartmentation;

Step 5) Coupling;

Step 6) Inspection, and

Step 7) Resizing.

Through the abovementioned steps, the process revealed in the present invention allows the implementation of electric fields that create environmental disturbances, capable of inhibiting incrustation of sessile organisms inside portions of marine waters under dynamic and/or static conditions, of ships, platforms of oil exploration, jetties etc.

For a perfect understanding of the invention, the steps abovementioned will be described in detail:

Step 1) Identification

The identification step 1) involves selecting the target surfaces or bodies.

This stage results from the choice, in a pragmatic way, by those responsible for the structure (jetty, ship, platform etc.) of which areas, sectors, or pipes of that structure should be the target of the technique.

In addition, stage 1) is segmented into two substeps, which are:

Substep 1a) Localization

Wherein the structure to be covered by the technique is analyzed together with its responsible operator, in order to identify the location and coverage of the technique.

Substep 1b) Dimensioning

Wherein such dimensioning will depend on the structure located in step 1a, with measurements in 3 dimensions being verified.

Step 2) Cleaning

It comprises the cleaning of bodies or surfaces, excluding previously adhered biofouling.

The application of the technique requires a surface free of sessile. As an example, in case of ships and other vessels, the hull must be cleaned in the floating or dry condition (docking), following the usual good techniques practiced by the operators of the structures.

Step 3) Measurement

In the referred step 3), the impedance measurement of the continent volumes of the clean surfaces is carried out between the intended location for equipment generating the electric fields and the coupling points, inductive or capacitive.

The impedance measurement is carried out between the coupling points by means of multimeters when planning the installation. It is necessary to determine the power that the equipment should provide. This measurement does not need to be constant, in real time, but it may be the subject of further sophistication for future equipment.

By the intended location for the equipment, it must be understood that it is according to the discretion of the operators, whether in situ or remote.

Equipment generating the electric fields must have points for power take-off, according to the availability of the operator.

By coupling points, it must be understood that these are the locations identified according to the characteristics of the structure, compatible with access for inspection, the highest level of sessile organism infestation in which the structure can operate and the power of the necessary equipment.

Step 4) Compartmentation

Wherein the surface of the submerged bodies is divided according to the power of the available equipment and the impedances found in step 3).

Compartmentation is understood as the division of the structure to be protected into blocks to be individually covered by equipment, as a segmentation of areas and/or volumes to be covered by equipment, depending on the structure to be worked.

Step 5) Coupling

In step 5) the coupling (resistive, inductive or capacitive) of the available equipment is carried out depending on the compartmentalization, the power of these and the impedances found in order to obtain electric fields of the order of +0.7 to −0.7 Volt/meter, which may vary depending on the dimensions of the structure to be worked.

Step 6) Inspection

Wherein the inspection of the target surfaces of the process is carried out every 30 months+/−6 months. The inspections to be carried out depend on the type of structure to be worked, accessibility, operational performance, and aggressiveness of the environment, and must be defined depending on the case.

Target surfaces are defined according to the characteristic of the structure to be worked.

Step 7) Resizing

Wherein the compartmentalization or power of equipment is resized according to the results.

Tests and Results that derive from the verification of fouling appearance within the period defined in paragraph

If this occurs, the compartmentalization or the increase in the power of the equipment, or even replacements, must be redone.

The present invention is described here in terms of its preferred modality, and it should be noted that changes made will still be included in the same scope of protection.

1. Process to prevent biofouling in marine, fluvial and lake environments characterized in that it creates electrical fields that generate environmental disturbances, capable of inhibiting incrustation of sessile organisms inside maritime, fluvial and lake waters under dynamic and/or static conditions, comprising the steps of:
Step 1) Identification;
Step 2) Cleaning;
Step 3) Measurement;
Step 4) Compartmentation;
Step 5) Coupling;
Step 6) Inspection, and
Step 7) Resizing
wherein step 1) comprises the substeps of:
Substep 1a) Localization, and
Substep 1b) Dimensioning.

2. Process, according to claim 1, characterized in that in step 1) the target surfaces or bodies are selected.

3. Process, according to claim 1, characterized in that in substep 1a) the structure to be covered is analyzed jointly with a responsible operator, in order to identify its location and coverage.

4. Process, according to claim 1, characterized in that in substep 1b) the measurements in 3 dimensions are verified.

5. Process, according to claim 1, characterized in that in step 2) the exclusion of previously adhered organisms occurs.

6. Process, according to claim 1, characterized in that in step 3) the impedance measurement of the continent volumes of the clean surfaces is carried out, between the intended location for equipment generating the electric fields and the resistive coupling points, inductive or capacitive; wherein said measurement occurs by means of multimeters when planning the installation, with the intended location defined between in situ or remote, while the coupling points comprise locations identified according to the characteristics of the structure, compatible with access for inspection, highest infestation of sessile organisms in which the structure can operate, and the power of the necessary equipment.

7. Process, according to claim 1, characterized in that in step 4) the structure to be protected is divided into blocks to be individually covered by equipment, segmenting areas or volumes to be covered by equipment, in accordance with the structure to be worked on.

8. Process, according to claim 1, characterized in that in step 5) is performed the inductive or capacitive coupling of the equipment available depending on the compartmentalization, the power and the impedances found, obtaining electric fields of the order of +0.7 to −0.7 Volt/meter, optionally varying according to the dimensions of the structure to be worked.

9. Process, according to claim 1, characterized in that in step 6) the inspection of the target surfaces of the process is carried out every 30 months+/−6 months, with the target surfaces being defined according to the characteristic of the structure to be worked.

10. Process, according to claim 1, characterized in that in step 7) the compartmentalization or power of equipment is carried out according to the results.
